(19) United States
(12) Patent Application Publication
(10) Pub. No.: US 2005/0149561 A1
(43) Pub. Date: Jul. 7, 2005

(54) Method and apparatus for creating and maintaining a GIS

(75) Inventors: Raymond J. Hodnett, Dover, NH (US); Dean S. Garfinkel, Rumson, NJ (US); Mark Catanese, Sea Bright, NJ (US); Alex Rystrom, Neptune, NJ (US)

Correspondence Address: Ralph W. Selitto, Jr.;McCarter & English, Four Gateway Center, 100 Mulberry Street, Newark, NJ, 07102, US

(73) Assignee: Jungle Lasers, LLC

(21) Appl. No.: 10/748,777

(22) Filed: Dec. 29, 2003

(51) Int. Cl. G06F 7/00

(52) U.S. Cl. 707/104.1

(57) ABSTRACT

A system for presenting a GIS and method for making and using one includes the necessary hardware and software for presenting a GIS over the Internet. The GIS is particularly useful for municipalities and has an interactive, searchable database containing map data and parcel related data, such as tax records and information useful to various departments in a town, such as the police and building licensing departments. A server computer running GIS software presents the map data and the parcel related data to town users over the Internet. The system includes means for updating the related data by utilizing a system where towns fax forms to the system which converts them to image files from which relevant data fields are extracted and evaluated by optical character recognition. To fund the establishment, use and maintenance of the system, citizens are charged fees for submitting data change transactions, i.e., when forms, such as a building application are submitted to the towns. Civil engineers participate in the system by, inter alia, buying licenses to use and market the system to towns, teaching the towns how to use the system, preparing and maintaining maps and otherwise functioning as technical experts mediating between the towns and the system owner.

### FIELD OF THE INVENTION

The present invention relates to apparatus and methods for creating, marketing, implementing, using and maintaining a data processing system utilizing a map interface, commonly known as a Geographic Information System (GIS). More particularly, the GIS is available to authorized users, such as municipalities, over the Internet.

### BACKGROUND OF THE INVENTION

GIS's are known and used as a tool to model and depict place-related information on a geographic map displayed on a computer screen. Of course, the information displayed on the screen can be printed out or otherwise stored and/or communicated, e.g., in a file that can be transmitted over the Internet. The map display typically acts as a graphical user interface whereby data associated with a particular location on the map can be accessed by “clicking-on” the location on a computer mouse. When a specific location is “clicked-on”, this causes the data associated with that location to be displayed on the screen, e.g., in text or table form. A GIS may be used by scientists, engineers, meteorologists, and various other persons with an interest in discerning geographically-related data patterns. For example, GIS's may be employed by municipal governments to assist in the planning, accounting and management functions towns must perform. In this instance, the GIS can provide a map representation of municipal geography linked to associated data stored in a database. In some instances, the data may be amenable to graphical mapping depiction, as in the case of water tables, elevations, zoning districts, etc. This is usually accomplished by “layering” simultaneous graphical overlays. In other instances, data is more suitably presented in a text format, such as in the case of data relating to ownership and tax payment records for a taxable parcel.

Many of a town's assets can be described geographically and depicted on a map, such as signage, curbing, sidewalks, trees, storm drainage systems, traffic signals, and roads. All of these assets depreciate over a “useful life”, e.g., a road is an asset with a limited useful lifespan. Higher traffic levels generally represent accelerated depreciation in a road's life, as can road openings for the installation or maintenance of below ground utilities. A GIS can aid officials in tracking assets and modeling the dynamic processes that adversely affect such assets for the purpose of better management and planning.

Most of the work towns perform is performed relative to parcels. For instance, garbage trucks travel a route and pick up garbage at known parcel-related points along the route, e.g., residential and commercial addresses. This is a materials and human resource planning problem about which insights can be gained through use of a GIS. Similarly, police patrols, school bus routing, leaf pickup programs and other municipal functions can be facilitated by a GIS. In addition, a GIS can facilitate municipal functions performed relative to point-specific assets, such as traffic lights, signage and fire hydrants.

A new federal accounting standard, (Government Accounting Standard Board-Statement-GASB 34), actually requires that government entities, such as municipalities who receive federal aid, must account for assets by 2007 in the same manner as businesses generally do, accruing costs and writing off the asset over time. Under this system, a town must depreciate its assets over their anticipated useful life, and allot funds for maintenance to achieve the design life of the asset. For example, a bridge that is funded with federal monies has an expected useful life, requires periodic maintenance and is affected by degrading factors and events such as car impacts and weather. Tools for assessing the aggregate impact of these kinds of depreciating assets can affect a town's ability to bond and will inform the town how best to tax.

While a GIS is a desirable tool for the management of geographically related assets, it has not been in common use by municipal government to-date. Barriers to its successful use include high initial costs for system design and implementation, data input, staff training, staff inertia, management shortcomings, and software and hardware requirements. Even if a town overcomes the initial barriers, it soon becomes evident that a GIS is only as good as the quality of its underlying database data, and that the normal operations of a town require the data for the GIS to be changed hundreds of times a day. Few towns are capable of committing sufficient resources to keep a GIS up-to-date. In addition to the need to input thousands of data changes yearly, GIS's involve large and continual software and hardware maintenance costs and the need for continual training of staff. Problems with retention of staff and the lack of technical skill of trained personnel have caused GIS deployment failures.

Accordingly, it remains an objective in the art to develop an improved GIS and methods for implementing, launching and maintaining them in real world situations, such as in the case of a municipal GIS.

### SUMMARY OF THE INVENTION

The limitations and disadvantages of prior GIS's and methods for making and using them are addressed by the present invention which includes a GIS having a database containing map data and related data. The related data is linked to the map data. A server computer running GIS software presents the map data and the related data in the database and is connected to the Internet. The system of the present invention includes means for updating the related data. In accordance with a method of the present invention for developing a GIS, a database structure for containing map data and related data linked to the map data is provided, as is a server computer running GIS software for presenting the map data and the related data. At least one map of a geographic area is created and stored in the database. Related data associated with the geographical area depicted in the at least one map is also stored in the database and linked to the map. This GIS is provided to users over the Internet and a fee is charged for data change transactions that affect the related data in the database.

### BRIEF DESCRIPTION OF THE FIGURES

FIG. 1 is a diagrammatic view of a system and a sample screen output showing a parcel map and various data processing selections in accordance with an embodiment of the present invention.

FIG. 2 is a data display, entry, and edit screen in accordance with an exemplary embodiment of the present invention for displaying, entering and editing data in a database of the present invention.

FIG. 3 is a schematic diagram of hardware and software components of a system in accordance with the present invention.

FIG. 4 is a schematic diagram of the processing, functions and data associated with three participants in a system in accordance with an embodiment of the present invention.

### DETAILED DESCRIPTION OF THE INVENTION

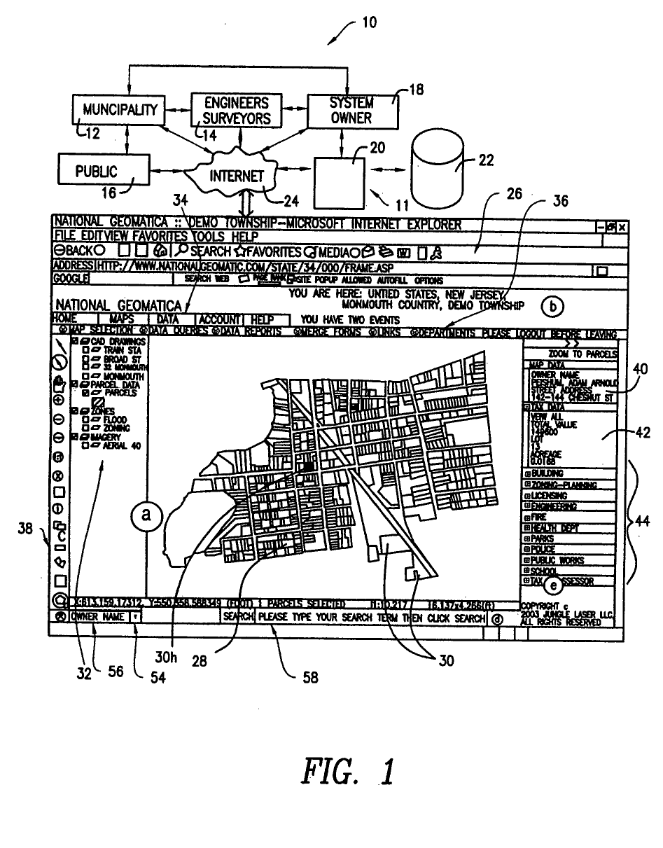

FIG. 1 shows a system 10 in accordance with the present invention, which incorporates and coordinates the capabilities and functions of federal, state and local governmental entities (hereinafter “municipalities”) 12, civil engineers and surveyors or anyone else with expertise in GIS's, such as architects, planners, GIS firms, geographers, cartographers and consultants (hereinafter “engineers”) 14, the public 16 and the system owner 18 to produce, fund, use and maintain a GIS 11 to the service and benefit of all parties. As shall be explained fully below, the system owner 18 assembles a hardware/software system 20 which stores and retrieves geographically related data obtained from municipalities 12, engineers 14 and the public 16 in a database 22. The data from the database 22 is then modeled as a GIS presented over the Internet 24 to authorized users, including the municipalities 12, the engineers 14 and the public 16. An exemplary screen display 26 in accordance with the present invention that would be displayed to a user via an Internet connection shows a map 28 representative of a geographic area, e.g., a town. The map 28 is subdivided into parcels 30 representative of ownership and/or taxable units, i.e., tax parcels. As will be explained further below, the database 22 stores data relating to features displayed on the map 28, e.g., related to tax parcels 30, roads or point-specific data, such as traffic signals, fire hydrants and potholes. The hardware/software system 20 includes a data processor 18 capable of running suitable data processing software, such as Microsoft® SQL Server and having the necessary server hardware and software, such as a Dell® PowerEdge 4600 running Microsoft® Server 2003, to maintain and serve a connection to the Internet 20 and also for running GIS software, such as Autodesk® MapGuide Server. The map 28 may include public structures and improvements, roads, signage, easements, plumbing, sewage, electrical, phone, gas, cable, and other utilities, bridges, traffic signals, etc. Various “layers” of information may be selectively represented graphically by different colors, cross-hatching, stippling, etc. to depict characteristics applicable to specific geographic areas displayed on the map 28, such as existing land use, zoning, floodplaines, voting districts, fire service districts, police patrol areas, etc. These types of layering options are depicted in the menu 32. The basic GIS software for implementing these features may be obtained commercially, e.g., Autodesk® MapGuide ActiveX Control by Autodesk, Inc. of San Rafael, Calif.

As shown in FIG. 1, two menus are available for the user, viz., a tab menu 34 with tabs labeled: home, maps, data, account, help; and a drop-down menu bar 36 with labels Map Selections, Data Queries, Data Reports, Merge Forms, Links, and Departments. On the tab menu 34, the home tab calls up the homepage, “maps” and “data” allow the user to toggle between the map view shown in FIG. 1 and a text view of the data associated with the map, e.g., parcel-related data, such as property tax data for a parcel. “Help” calls up on-line help. In menu bar 36, “Map Selections” displays a drop-down menu list of previously saved views of the maps. “Data Queries” displays lists of previously composed and saved queries and “Data Reports” permits the user to review and reprint previously composed and saved reports. “Merge Forms” calls up a text editor which permits data fields to be specified therein, allowing the user to perform a “mail-merge” type production of documents with data fields filled in by the relevant values stored in the database 22, “Links” displays related Internet addresses, such as the home page for a town. “Departments” provides general introductory information for a selected department, e.g., the hours, personnel and functions performed by the departments and may be used as an access path to obtain parcel-specific information relevant to a selected department. A conventional map toolbar 38 accesses the built-in functions of MapGuide, to perform a number of tasks such as zoom, pan, select, etc. One means of accessing data from the database 22 pertaining to a particular displayed feature is to “double click” on the displayed feature, e.g., a tax parcel 30, then the data associated with that particular parcel 30h is accessed and displayed. It should be appreciated that additional tabs calling out additional functions can be utilized. For example, a tab labeled Doc/Man can be utilized to activate a document manager function which enables a town to attach a database of previously scanned files or folders or to scan directly to web server 76 via a digital sender 75, such as a Hewlett Packard® 9100C. In this instance, the website will emulate a file folder structure similar to that used by the municipality 12.

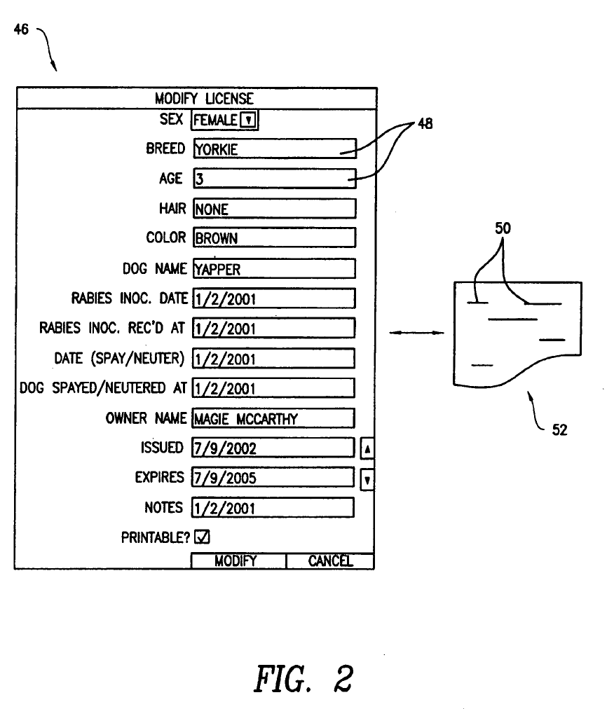

FIG. 1 shows the selected parcel 30h as highlighted. The display 26 also has a display area 40 entitled “Map Data” and showing basic parcel information, viz., owner name and street address. Any desired data fields could be displayed in this area, such as: lot number, owner and phone number, resident name, address and phone number, the identification of all persons known to live at that address, etc. A display area 42 labeled “Tax Data” shows data fields: Total Value, Lot and Acreage, associated with the selected parcel 30h. The display areas 40, 42 can be enlarged to reveal additional data, e.g., display area 42 could also show the assessment history, taxes paid, value of improvements, etc. A plurality of buttons 44 are arrayed below the second display area 42 and represent municipal departments which have various data collection and use objectives, typically organized relative to topical forms (and generally filed by lot and block number or address). For example, the building department of a town would be involved with building applications, building inspection reports, certificates of occupancy, etc. Each of these topical forms calls for a plurality of data fields. The system 10 of the present invention links the data relating to parcel 30h, such that a user, e.g., municipality 12, may access the form data associated with each of the municipal departments serviced by the system 10 by selecting the appropriate button 44 and then selecting the appropriate topical form. For example, the police button calls out a menu including gun permits, dog licenses, accident reports, traffic tickets, etc. (These forms can be moved to or shared with/by other departments, e.g., dog license data can be used by police, animal control and health department.) From this menu, if the user selects “dog licenses”, a topical data screen 46 as shown in FIG. 2 is displayed. The data screen 46 displays data fields 48 corresponding to data fields 50 on a paper form 52 (dog license application) which would be employed by the municipality 12 to register a dog at the municipal building. The data screen 46 available with the system 10 could be used for various reasons, e.g., the police may want to check if a dog spotted on the property in question (the selected, highlighted parcel 30h) has a valid license. By way of another example, the dog owner may have presented updated inoculation data to the police and they wish to update the licensing data in the database 22 by editing the data fields 48 displayed on the screen 46 and saving the edited data to the database 22 (Modify). In this manner, if a person reports a dog bite occurring at the property in question 30h, the dog license data recorded in the database 22 will show current inoculation information whereby the bite victim can avoid unnecessary rabies treatment. In each of the foregoing instances, the benefits of an on-line, paper-less system 10 are evident. Namely, the relevant data is easily retrieved, either through the map 28 graphical interface or by searching, e.g., based on the breed and color of the dog. This can be done by anyone connected to the Internet 24, such as a police officer using a laptop with a wireless connection in his patrol car.

Each of the departments in a municipality 12, such as the zoning and planning department, the fire department, the police department, etc., utilize paper forms (which are sometimes required by law) like form 52 for performing their daily functions for the public 16. These forms represent logically grouped collections of data 50. From the standpoint of the system owner 18, these forms constitute a “product” in the sense that the ability to process a form by collecting and storing the data associated with that form is a function having a discrete value. This is also true from the standpoint of the municipal users of the various forms and form data. The system 10 maintains a comprehensive and expandable database of parcel-related information for the town and can include any required data for “products”. The system 10 provides several ways to view data for most products. Each product has a homepage which can be accessed by clicking the department's button 44. These homepages contain general information and town-wide data relating to the products and the department. As noted above, to view parcel-specific information for a product, a search may be conducted or the parcel 30h may be double-clicked and the appropriate department and product selected.

Exemplary Products for Various Municipal Departments would Include:

(i) Building Department: building applications, building subcode, certificate applications, certificates, inspection schedules, inspection scheduling, rental inspection, rental testing, rental unit registration, UCCARS submission;

(ii) Health Department: oil spills, septic system, well permits;

(iii) Planning Board: planning board applications, Planning/Zoning inspection scheduling, site plan applications, subdivision applications, violations/complaints, zoning board applications, zoning permits, zoning tracking;

(iv.) Police: dog licenses, accident reports, crime data;

(v.) Public Works: refuse pickup;

(vi.) Tax Department: tax Information;

(vii) Zoning-Planning: application denial, application for appeal, application for zoning permit, plan review, planning board applications, PZ inspection scheduling, site plan applications, subdivision applications, violations/complaints;

(viii) Various Additional Miscellaneous Forms: fire inspections, rental unit updates, document bundles, pocket PC inspections, DARM/OPRA (Division of Archives and Records Management (NJ)/(Open Public Records Art), street opening permits, and utility work orders.

For simple searching, the drop down menu 54 on the searching frame 56 is selected, revealing fields, such as street address, owner name, block, lot, acreage, owner address, deed page, etc. (as determined by the municipality 12). Any of these fields may be selected for searching. The particular data value that is to be searched for in that field is then specified in the search entry 58 by the user. Advanced searching is also available wherein multiple fields in multiple products (even across different town departments) can be simultaneously searched for a combination of data items. Advanced searching searches across multiple different products that are linked to a single property. In this manner, a plurality of data values for a corresponding plurality of data fields and products can be used to structure a compound search. The searching strategy can be saved, printed out or combined with other search results, and the results displayed texturally or on the map 28, either by combining both sets of search results, just showing overlapping results, showing all areas except where the results overlapped, and showing the results obtained from subtracting the second set of results from the first set.

The map 28 and its associated database 22 are interactive, in that the system 10 supports queries to the database 22 and converts the results into graphical features displayed on the map 28. For example, in response to a query that asks the question “Show all commercially zoned properties that are greater than 5 acres in size, and have transferred title within the last 2 years”, a map 28 is drawn and a list created of the properties that meet the criteria of the search. In another example, the user might use the map 28 of the town to locate the residence of a paroled child molester, e.g., Megan's Law parolee, and draw a 1000′ radius around the property. A list would then be created that would allow the town to notify all property owners within the designated area, as required by law. The system 10 provides the facility to create documents and associate those documents with products or parcels. A scheduler is also provided to be used with any product or department requiring scheduled events, such as inspections or meetings.

It is preferred that various levels of user access to the system 10 be provided, with the lowest level being a public user who is able to view maps 28 and data, but not detailed information, and has no means for changing the data in the database 22. A town employee user, on the other hand, would have access to enter and edit data and perform other functions related to their specific job. For example, a member of the police department may be able to view and modify dog license data, but may not have access to road department data. A group administrator level of access permits data to be edited, created, and also accesses the functions that control user access. At the highest level, namely town administrator, all data is accessible and modifiable. A town administrator has control over access rights for all group and individual users, can change the look and feel of the website and may add or remove products from the system 10.

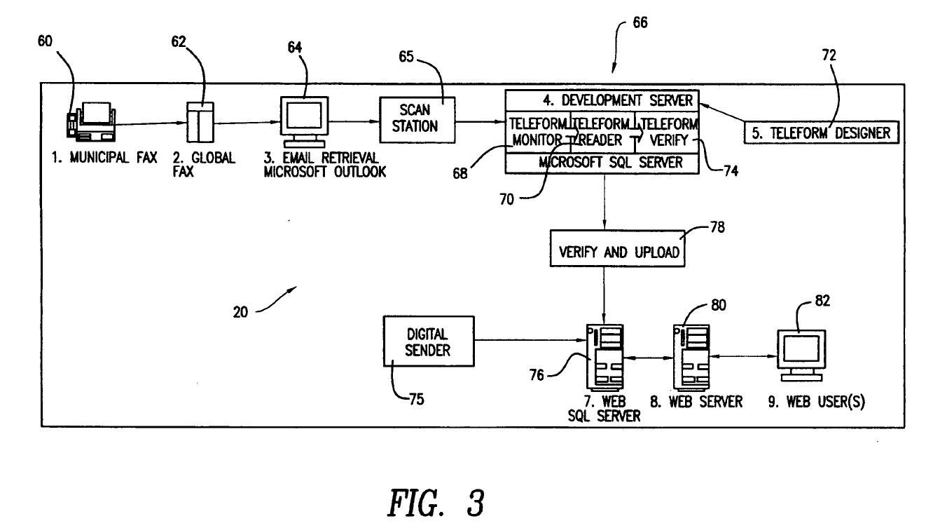

FIG. 3 shows a hardware/software system 20 for implementing the present invention. More particularly, a municipal fax machine 60 located in a municipality may be utilized to fax paper form documents 52, such as building permits, zoning applications, dog licenses and various other products, to a fax machine 62 capable of converting the fax to a “tiff” image file or any electronic graphic form such as jpg, png or gif. This service is available commercially, e.g., as provided by Global Fax Network of Chula Vista, Calif. The image files are then e-mailed as attachments to a first computer system 64 maintaining an e-mail account for the system owner 18. Preferably, an individual fax number to connect to fax 62 and a separate e-mail account is maintained on computer 64 (any standard Windows 98+ workstation) for each municipality 12 and/or departments within a municipality. The e-mails are automatically retrieved using Microsoft® Outlook or Outlook Express and processed by a rule defined to save any attached files (the image files) to a network folder. A scan station 65 may be utilized to group emails from a common source, e.g., a specific municipality 12 and/or of a common type, e.g., a specific type of form, into batches to facilitate the process of verification 78 which shall be described below. The image files are then automatically saved on the development server 66. The development server 66 includes a Cardiff® TELEform Monitor 68 from Cardiff Software, Inc. of Vista, Calif. that automatically scans the specified network folder to see if any files have been added. If a file was added, the TELEform Monitor software sends the file (or batch of files) to a Cardiff® TELEform Reader 70. The TELEform Reader 70 recognizes the images as a form e.g., 52 that has been previously entered in Cardiff® TELEform Designer 72. After identifying the form, e.g., 52, the data fields 50 are OCR'd (optical character recognition) to determine their data value. Note that this process also encompasses the reading and evaluation of handwritten data 50 through a process called ICR (intelligent character recognition). A Cardiff® TELEform Verify 74 connected to the network will connect to this application to verify that the information has been OCR'd/ICR'd by the TELEform Reader 70 software. This is to correct any errors that have occurred in the process. The Cardiff® TELEform Designer 72 is the program which defines the identifying marks on a scanned image such as a printed form 52 The TELEform Designer 72 may be used to create a form 52 for use by municipalities 12 and having a numerical or barcode identifier that permits the form 52 to be recognized by the system 10. (The TELEform Designer 72 would be utilized by personnel of the system owner 18.) These marks are used to register the image as documents of a specified type in the TELEform Reader 70 software. Data fields 50 in the document 52 that are to be read and OCR'd/ICR'd are defined in this step as well as the mapping of these fields for an SQL server 76. The Cardiff® TELEform software 66, 70, 72 and 74 are provided in a suite which includes a suite manager that can be used to track the time and efficiency of the data processing for many batches and users.

The resultant fields 50 are then verified and uploaded 78 to the web SQL server 76, such as a Dell® PowerEdge 2650. During verify and upload 78, the field data 50 is displayed or printed out. The listing is then compared to the related tiff image and is edited to conformity. The Cardiff Verify fields are cross-referenced to the database 22 or another existing database containing key fields, such as: “street address” or “contractor name”. Verification 78 can also be conducted automatically by a program to compare form data from the Cardiff Verify module to existing data in the database 22, e.g., to determine if the block and lot exist or were transposed. This checking can be facilitated by performing data parity checking. This process is intended to avoid the corruption of the database by the entry of incorrect data from a paper from that, e.g., has been incorrectly completed at a jobsite by a tradesman under adverse conditions. Besides block and lot, other identifying data can be checked, such as street address or lot identification number (usually a concatenation of Block and Lot plus additional data). Parcels conforming to the database 22 may be displayed in green and non-conforming lots flagged in red. Red parcels may be updated with corrected information or are “forced” on the system 10 for later verification and acceptance by the municipality 12.

Two-page forms (or greater) are linked together to form a single form after having been received by fax as two or more distinct pages. Linking is triggered by “reading” the uniquely assigned file number that each page receives and manually attaching one to the other with on-screen tools. The program used for Verify and Upload 78 is also a file transfer program, and is used to send received data from local server 66 to Web SQL server 76. As data appears on the webserver 80, it is displayed as flagged, or in red, to show it requires verification, either by a manager of the system owner 18 personnel of the municipality 12. Once verified as being in a form that is suitable for the online database 22, the manager or municipal personnel responsible, can clear the data online to enter and update the official web database 22. Multiple page form documents 52 are linked and the field data 50 is tagged by “product” identity. The data 50 is then uploaded from the local SQL server 76 to the live (web) SQL server 80, e.g., a Dells PowerEdge 4600. The information then resides in database 22 on the web SQL server 80.

The web server 80 allows the end user 82, such as a member of the public 16, to interact with the database 22 to access form data 50 through the system 10, as described above. The interaction is in real time, if desired, e.g., a form 52 can be read by the system 10 in one-half to three minutes, allowing the issuance of certain over-the-counter permits. As noted above, data can be entered into the system 10 by various means, e.g., by entering data into a screen, by direct scanning to the web server 80 via a digital sender 75 or by faxing a paper form 52 to a designated fax machine 62. In this manner, use of the system 10 is accessible even by those who are not highly trained in computer systems. For this reason, the integrity of the data is maintained even though it depends on a computer illiterate person or persons that do not have an Internet connection, e.g., they can simply “fax” the appropriate form and the data will automatically be extracted. Because there are alternative means for keeping the data in the database 22 current, the system 10 is resistant to degradation due to one or more individuals who are incapable of using one or another of the alternative means.

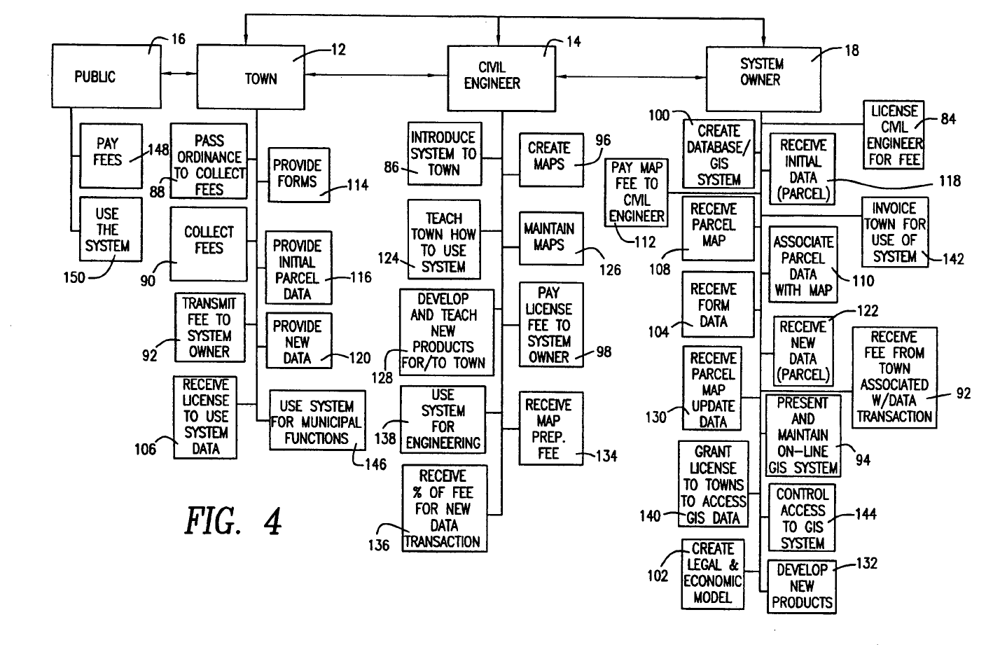

The present invention includes structures and methodology to solve the problems usually encountered by a town in developing, using and maintaining a GIS, viz., the funding of the initial GIS and the ongoing maintenance of a complex database beyond the skill level of most towns who would use the system. Referring to FIG. 4, the present invention contemplates the sale 84 of licenses to engineers 14, who offer 86 the system 10 for free to towns 12. Towns 12 pass ordinances 88 to collect slightly higher application fees, collect 90 the fees and pass them 92 to the system owner 18 to pay for access to up-to-date information. The system owner 18 receives 92 the fee and uses those funds to present and maintain 94 the system 10. If higher application fees are not desired, the municipality 12 can opt to pay on a monthly basis out of general funds based on an estimated monthly flow of documents or may utilize a modest fee increase in conjunction with a monthly payment.

The present invention combines the capabilities of 3 different entities to make a unified system, viz.: (i) towns 12, which have the police power to enforce payment of fees used to update the database; (ii) civil engineers and surveyors 14 who have unique expertise in the creation and maintenance of maps, specifically tax maps (which must be maintained by a licensed professional), and (iii) the system owner 18, who has expertise in maintaining large databases, distributing content via the Internet, e.g., developing the programming and workflow processes for “reading” typed or handwritten data into databases and merging that information with maps into an on-line GIS, as well as coordinating and incentivizing the towns 12 and engineers 14 to perform their respective functions required for developing, launching, using and maintaining the system. By way of incentivising, the present invention is designed to give towns a no-obligation GIS for free. The risk of capital and stigma of possible failure are, therefore, eliminated. The development of the GIS is funded and maintained by others and the town gets to use a very sophisticated system in its management role and discharge of its public health, safety and general welfare functions. Local engineers 14 may be a source of “venture capital”, as well as a sales force to whom commissions on monies collected from the town, are paid. Engineers receive revenue generated by user update fees. They also participate for the strategic benefits they hope to reap in providing their client municipalities with a valuable GIS. These include upgrades to original mapping and other consulting services. Finally, the system owner participates in user update fee revenues and also has access to the data collected.

As noted above, GIS is difficult to create and even more difficult to maintain. The core competencies required for creation and maintenance of a GIS are specific to neither engineers nor towns, yet both should be involved. Recognizing that towns have generally failed in the past due to budgetary and personnel staffing problems, the present invention may utilize civil engineering firms 14 to act as technical staff in the preparation and maintenance 98 of GIS maps. Recognizing that engineers 14 have no specific skills in database maintenance and no skills in software and hardware servicing, they cannot alone fill the roles necessary for successful GIS deployment. However, engineers are trusted consultants often performing functions for towns with great professionalism and skill. The relationships they have formed with municipal governments whom they represent are often long and deep, based upon a track record of performing on the municipality's behalf. Though they have often advised municipalities on the benefits of GIS, until the development of the present invention, a GIS would be too daunting an endeavor for most municipalities.

In accordance with the present invention, the system owner 18 takes the risks associated with GIS deployments and shares those risks with the consulting civil engineer 14. The engineer 14 pays 98 the system owner 18 a license fee for the right to offer 86 the system 10 to a specific town 12. The engineer 14 and/or the system owner 18 presents the system 10 as a solution that solves the problems of traditional GIS deployments. Alternatively, the system owner 18 can introduce the system 10 to the municipality 12 directly. Towns 12 have no upfront or ongoing costs, so they do not have to worry about staff training, keeping technologically up-to-date or maintaining a significant information technology staff. The engineers 14 know the inconsistencies in a town and represent a large and well trained staff for the system 10.

The steps in the development, distribution, use and maintenance of the system include the development of the system hardware and software configurations 100. In addition, the legal and contractual relationships and funding model required to allow deployment of the system must be designed 102 by the system owner 18. Engineers 14 then buy 98 licenses from the system owner 18 allowing them to offer the system 10 to a specific town 12. The engineer 14 therefore operates under a distributor agreement. The engineer 14 presents 86 the system 10 to the town 12 explaining its benefits. Upon a town 12 agreeing to use the system 10, the system owner 18 pays 112 the engineer 14 to prepare 96 a GIS map 28 of the town 12. The town 12 provides 114 forms 52 and provides 116 initial parcel data to the system owner 18. The system owner 18 obtains 104 copies of the town's forms 52 and creates 100 the hardware/software system 20 that will allow it to “read” data 50 faxed to the system 10 by towns 12. The town passes 88 ordinances authorizing new fees to be charged in association with data transactions, i.e., use of products, and executes 106 an end-user agreement (by resolution of the governing body) with the system owner 18. Upon receipt 108 of the engineer's map and receipt 118 of the initial parcel data, e.g., as provided by the town's tax assessor or other agencies or personnel, the map is matched (geocoded) 110 to the initial parcel data. A software tool may be used to link data and parcels, e.g., tax map data files to scanned tax maps. The map 28 is then posted to the Internet 24 and towns 12 can begin accessing the GIS 10 and managing the data in the database 22. Data is maintained (updated) by faxing relevant new information to the fax machine 62 or by inputting information directly into the on-line database 22 using the on-line GIS 10. In this manner, towns 12 provide 120 and the system owner 18 receives 122 new data pertaining to new data transactions, e.g., submitting a new application for a building permit or a dog license. Engineers provide technical support to the town by teaching 124 the towns 12 how to use the system 10, by maintaining 126 maps to reflect changes like a new road or subdivision, and help the town develop 128 new products that would allow processing of new forms. The system owner 18 receives 130 and processes the new data, maintaining 94 the database driving the GIS and developing 132 new products to deliver the most functional GIS possible. The engineer 14 receives 134 fees for the preparation of maps and may also receive 136 a percentage of the fees associated with new data transactions. The engineer 14 also has the benefits associated with using 138 the system 10 for engineering purposes.

Each of the above steps has elements leading the entities 12, 14, 16 and 18 to agree to participate in the system. The present invention 10 has an embedded rationale that is critical in allowing each entity, i.e., the town 12, the engineer 14, and the system owner 18 to participate in creating and/or maintaining the system 10. More particularly, towns 12 are the beneficiaries of the enormous investment and thought expended by the system owner 18 to create the system 10. The system 10 provides engineers 14 with a way to introduce their municipal clients 12 to a no-cost method of employing a powerful management tool, allowing them to expand their core competence to GIS in a way that provides excellent returns for the risk taken. The system owner 18 realizes in the engineers 14 a team of GIS professionals trained in the system's methods of production, who are willing funders of the system and who understand the potential rewards. The engineers 14 are, in effect, a broad sales network.

The system owner 18 grants 140 a license to the town 12 to give the towns 12 access to the data in the database 22 and may invoice 142 the town 12. The charge may represent a fee to view and use information in electronic form, as opposed to payments for services rendered in creating the system 10 or the database 22. The system owner 18 may retain the right to aggregate data. The municipality 12 may require the system owner 18 to refrain from distributing the data. In this manner, the system owner 18 controls 144 access to the GIS 10 and allows the town 12 to use 146 the system 10. The public 16 interacts with the system 10 using 150 the system 10 as authorized by the municipality 12. As noted above, the municipality 12 may charge its citizens increased fees associated with data change transactions. Towns 12 are generally required to use a selected group of revenue products at launch in order to pay for the system, e.g., site plan and subdivision applications, building permits and certificates of occupancy. Alternatively, a predetermined license fee may be paid by the municipality 12. In marketing the system 10, the system owner 18 can easily identify a core group of municipal engineers 14 that represent a significant portion of a state's towns 12, reducing the marketing effort to appeals to these few firms instead of hundreds or thousands of towns in a state. Engineers 14 may purchase licenses for marketing purposes to service towns 12 where they have no prior relationship, and to deepen their relationship with existing client towns 12. Towns 12 get a free electronic parcel map 28 of the town 12, which is the first step in creating an electronic tax map. Alternatively, the system owner 18 may directly market the system 10 to the municipalities 12, who then encourage the participation of the engineers 14 in the system 10.

Two agreements may be used to govern the actions of the parties, viz., a distributor agreement between the system owner 18 and the engineer 14 describes the revenue share from transactions and other payments and responsibilities. An end-user agreement may be used between the system owner 18 and the town 12 that uses the system 10, which is structured to allow the town 12 to collect fees from applicants that cause changes to occur in the database 22. However, the system 10 may be structured such that the town 12 does not pay for the processing of any documents 52. Rather, the fees the town 12 pays 92 the system owner 18 may be made in payment for a license to view and use a copyrighted data collection. As a result, the processed data does not enter the public domain. The system owner 18 may license the use of the data to the town 12 in perpetuity and for all legitimate uses the town has in respect to management and planning. The present invention therefore provides financial and non-financial inducements that cause disparate parties with differing skill sets and motivations to cooperate in creating, using and maintaining a GIS. The system integrates map, database, updating capability, hardware, software, Internet availability, use and easy access for all. It employs the power of towns to compel delivery of information and collect fees. It uses the special skill set of engineers as indirect providers of GIS to the towns, employing their professional skills in unique ways and incentivizing them to service and contribute funding for the system.

It should be understood that the embodiments described herein are merely exemplary and that a person skilled in the art may make many variations and modifications without departing from the spirit and scope of the invention as defined in the appended claims. All such variations and modifications are intended to be included within the scope of the present invention as defined in the appended claims.

1. A system for presenting a GIS, comprising:
(A) a database containing map data and related data, said related data linked to said map data;
(B) a server computer running GIS software for presenting the map data and the related data, said server having access to data in said database, and connected to the Internet;
(C) means for updating said related data.

2. The system of claim 1, wherein said map data pertains to a political unit and said related data pertains to governmental functions conducted by said political unit.

3. The system of claim 3, wherein said political unit is in the nature of a municipality and said governmental functions include public service, public works, taxing and police power.

4. The system of claim 3, wherein said governmental functions utilize forms for obtaining, storing and reporting data, said related data including data derived from said forms.

5. The system of claim 4, wherein said means for updating includes computer processing apparatus and software for converting faxed forms into said related data having a digital value corresponding to an actual value.

6. The system of claim 5, wherein said computer processing apparatus includes first means for converting a faxed form into an image file and second means for extracting said related data from said image file.

7. The system of claim 6, wherein said second means for extracting include means for recognizing data fields in said image file and means for converting the data fields into digital values by at least one of optical character recognition and intelligent character recognition.

8. The system of claim 7, wherein said means for updating include a fax machine from which a form bearing written data is sent as faxed data and a fax receiver that receives and converts the fax data into said image file

9. The system of claim 8, wherein said image file is in at least one of tiff, jpg, png, pdf and gif formats.

10. The system of claim 9, further including visual comparison means for presenting the image file and the data values derived therefrom to a human receiver to allow verification that the data was converted correctly.

11. The system of claim 10, further including a data server for serving said database to said server computer for transmission of the related data over the Internet.

12. The system of claim 1, wherein said related data in said database is subject to searching based upon search terms.

13. The system of claim 12, wherein the searching conducted may combine search terms for a plurality of data fields.

14. The system of claim 12, wherein said related data is displayable in text or map form.

15. The system of claim 15 wherein said related data pertaining to a parcel of property can be accessed by selecting the parcel from the graphical map interface or by selecting a municipal department having responsibility for processing forms containing said related data sought.

16. A method for developing a GIS, comprising the steps of:
(A) providing a database structure for containing map data and related data linked to said map data;
(B) providing a server computer running GIS software for presenting the map data and the related data, said server computer having access to data in said database, and connected to the Internet;
(C) creating at least one map of a geographic area and storing it in the database;
(D) storing related data associated with the geographical area depicted in the at least one map in the database;
(E) linking the map to the associated data;
(F) providing the GIS to users over the Internet;
(G) charging fees to the users of municipal services for data change transactions that effect the related data in the database.

17. The method of claim 16, wherein the database structure, the server computer and the GIS is owned by a system owner and the data change transactions are associated with municipal transactions between a municipality and an entity seeking municipal services, said entity paying a fee to the municipality in response to said step of charging.

18. The method of claim 17, wherein the data change transaction includes the submission of change data by the entity to the municipality.

19. The method of claim 18, wherein the change data is presented on a written form.

20. The method of claim 19, wherein the written form is selected from the group consisting of building applications, building subcode, certificate applications, certificates, inspection schedules, inspection scheduling, rental inspection, rental testing, rental unit registration, UCCARS submission, Uniform Construction Code submission, oil spill forms, septic system forms, well permits, planning board applications, Planning/Zoning inspection scheduling, site plan applications, subdivision applications, violations/complaints, zoning board applications, zoning permits, zoning tracking, dog licenses, accident reports, crime data, refuse pickup, tax information, application denial, application for appeal, application for zoning permit, plan review, fire inspections, rental unit updates, document bundles, pocket PC inspections, DARM/OPRA, street opening permits, and utility work orders.

21. The method of claim 17, further comprising the step of the municipality paying a fee to the system owner for data change transactions.

22. The method of claim 17, further comprising the step of an engineer purchasing a license from the system owner to use the GIS.

23. The method of claim 22, further comprising the step of the engineer introducing the GIS to the municipality.

24. The method of claim 22, further comprising the step of the engineer teaching the municipality to use the GIS.

25. The method of claim 22, further comprising the step of the engineer offering use of the GIS to the municipality free of charge, except for the payment of fees associated with data change transactions.

26. The method of claim 22, further comprising the step of the engineer making maps for incorporation into the GIS.

27. The method of claim 26, further comprising the step of the system owner receiving the maps made by the engineer and paying the engineer a map-making fee.

28. The method of claim 27, further comprising the step of the engineer preparing updates for the maps provided.

29. The method of claim 22, further comprising the step of the system owner modifying the database to accommodate new types of related data associated with new forms serviced by the GIS after the step of providing a database structure.

30. The method of claim 22, further comprising the step of the system owner licensing the municipality to use the database.

31. The system of claim 6, wherein said means for updating including a digital sender for communicating related data into the database.

32. The system of claim 10, further including digital comparison means for conducting a data parity check to allow verification that the data was converted correctly.

33. The system of claim 10, further including means for grouping related image files into the batches to facilitate verification that the data was converted correctly.

34. The system of claim 6, wherein said means for updating include means for communicating related data in the form of a previously scanned document into the database.

35. The system of claim 1, wherein said means for updating said related data include a plurality of different means, at least one of which can be employed by a user without use of a computer.

36. The system of claim 6, wherein said second means for extracting include means for recognizing data fields in said image file and means for converting the data fields into digital values by intelligent character recognition.

37. A method for developing a GIS, comprising the steps of:
(A) providing a database structure for containing map data and related data linked to said map data;
(B) providing a server computer running GIS software for presenting the map data and the related data, said server computer having access to data in said database, and connected to the Internet;
(C) creating at least one map of a geographic area and storing it in the database;
(D) storing related data associated with the geographical area depicted in the at least one map in the database;
(E) linking the map to the associated data;
(F) providing the GIS to users over the Internet;
(G) charging the users of the GIS for viewing data in the database.

38. The method of claim 37, wherein the step of charging fees is triggered when data is viewed pursuant to a data change transaction.

39. The method of claim 38, wherein the step of charging fees is conducted in advance of the data change transaction based upon an estimated volume of data change transactions.
